(19) United States
(12) Patent Application Publication
(10) Pub. No.: US 2008/0190079 A1
(43) Pub. Date: Aug. 14, 2008

(54) Engine and Method for Removal of Moisture from Turbocharged Intake Air

(76) Inventor: Julius W. Cerdes, Ponchantoula, LA (US)

Correspondence Address: McGLINCHEY STAFFORD, PLLC, 4703 BLUEBONNET BLVD, BATON ROUGE, LA, 70809, US

(21) Appl. No.: 11/997,118

(22) PCT Filed: Jul. 28, 2006
(86) PCT No.: PCT/US06/29155

§ 371 Date: Jan. 28, 2008

(30) Foreign Application Priority Data
Jul. 29, 2005 (US) 60703776

(51) Int. Cl. B01D 50/00

(52) U.S. Cl. 55/319; 60/614

(57) ABSTRACT

An apparatus assembly for an internal combustion engine, the apparatus including a liquid trap configured for fluid communication with an air intake conduit, to thereby receive at least a portion of condensation which forms within the air intake conduit when the conduit is feeding substantially humid, aftercooled and turbocharged air into an intake manifold of an internal combustion engine. The apparatus improves the useful life of internal combustion engines equipped with aftercoolers, especially those operated in ambient conditions of high relative humidity.

### FIELD OF THE INVENTION

The present invention pertains to the field of internal combustion engines, and in particular to the field of turbocharged engines equipped with an aftercooler for conditioning compressed intake air.

### BACKGROUND

Internal combustion engines of commercial grade are called upon by their users to generate significant levels of power for long periods of time on a dependable basis. Many such commercial-grade marine diesel engines, for example, depend upon turbocharging to compress the airflow before it enters the intake manifold of the engine in order to increase power and efficiency. However, turbocharging typically elevates the temperatures of the intake air to an extent that causes the formation of undesired exhaust by-products, e.g., various nitrogen oxides (NOx), especially in engines run under strenuous conditions. To combat this problem, engine manufacturers have historically employed a device known as an aftercooler (or alternatively an intercooler), essentially a heat transfer device which transfers heat from the turbocharged air exiting the turbocharger. In marine applications, these aftercoolers often are configured to employ seawater flowing through a matrix or grid across which the hot, turbocharged air flows for cooling. Of course, other coolant configurations may be used, e.g., jacket water cooling, engine coolant, etc. Regardless, and unfortunately, this heat transfer operation, especially when conducted in conditions where the ambient air flowing though the turbocharger and aftercooler is substantially humid (i.e., greater than 50% relative humidity), can cause moisture condensation to occur downstream from the aftercooler within the conduit through which the intake manifold receives the turbocharged airflow. The condensation in the form of an aqueous liquid makes its way into the intake manifold, thereby entering the engine block and causing the engine to corrode and wear or fail prematurely. For this reason, many combustion engines equipped with turbochargers and aftercoolers, when operated in humid ambient air conditions, provide less than ideal performance.

### THE INVENTION

The present invention addresses this and other issues in the field by providing, in one embodiment, apparatus comprising a liquid trap sized and configured to be placed in fluid communication with an air intake conduit and to thereby receive at least a portion of condensation which forms within the air intake conduit when the air intake conduit is feeding substantially humid, aftercooled and turbocharged air into an intake manifold of an internal combustion engine. In some embodiments of the invention, the apparatus further comprises a collection reservoir, the reservoir being in fluid communication with the liquid trap to receive liquid therefrom. Alternatively, or in addition, the apparatus may further comprise a liquid level sensor operatively connected to the collection reservoir to thereby detect when a pre-selected level is reached by liquid in the collection reservoir and emit a signal indicating that the pre-selected level has been reached. Still other embodiments of the invention are characterized so that the liquid trap comprises a hollow conduit configured for fluid communication with the intake air conduit so as to open on one end to an air passageway formed by the air intake conduit. The hollow conduit is closed on the other end except for a drain opening disposed to feed into a drip line conduit sized and configured to convey liquid from the hollow conduit.

Another embodiment of the invention provides, in an internal combustion engine equipped with at least an intake manifold, a turbocharger for compressing a flow of intake air, an aftercooler device for reducing the temperature of the intake air flowing from the turbocharger, and an air intake conduit for conveying intake air exiting the aftercooler device to the intake manifold, the improvement comprising at least one device comprising the aforesaid liquid trap.

Yet another embodiment of this invention is a method of preventing water damage to a turbocharged, aftercooled internal combustion engine. The process comprises collecting in a liquid trap, during operation of the engine, at least a portion of condensation formed in an air intake conduit extending between the aftercooler and the intake manifold, so as to prevent at least an appreciable amount of condensation liquid from entering the intake manifold, the liquid trap being in fluid communication with the air intake conduit.

The various embodiments and features of this invention will now become further apparent from the following detailed description, the accompanying drawings and the appended claims.

### SUMMARY OF THE DRAWINGS

FIG. 1 is a view, in perspective and in partial cross-section, of one embodiment of the present invention.

FIG. 2 is a view, in perspective and in partial cross-section, of another embodiment of the present invention.

FIG. 3 is view, in perspective and partially broken away, of the collection reservoir component of the embodiment of FIG. 1.

Like numbers, letters or other symbols across the various figures are used to refer to like parts or components amongst the group of figures.

### DETAILED DESCRIPTION OF THE INVENTION

The present invention provides a simple yet highly effective way to remove undesirable liquid from the intake system of combustion engines exposed to intake airflow with relatively high humidity, conditions commonly found in marine applications and in geographic regions where tropical or subtropical weather conditions are common.

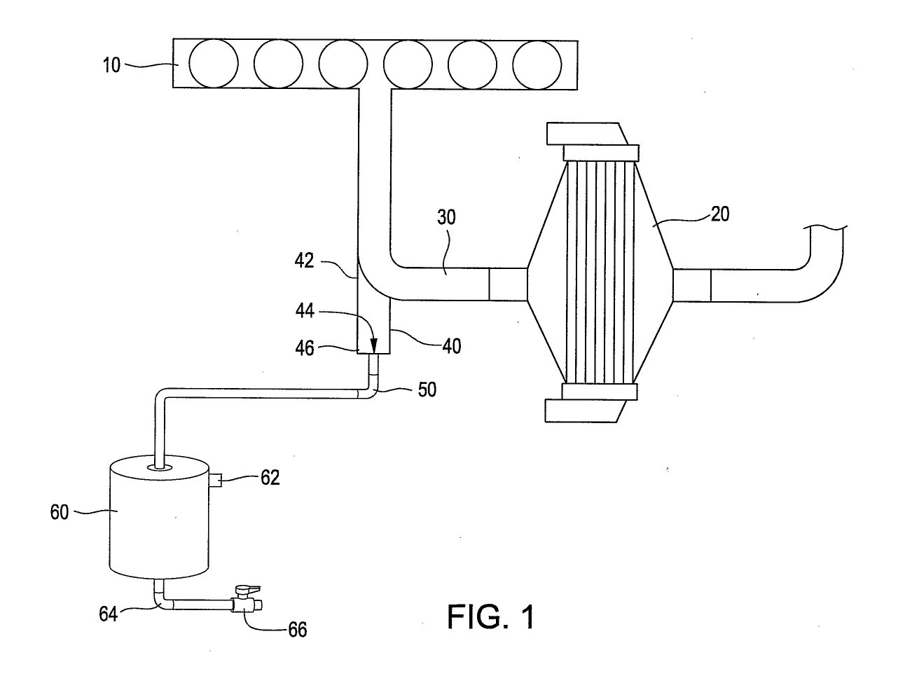

FIG. 1 is illustrative of one particular embodiment of this invention. There represented is a conventional intake manifold 10 of a combustion engine, an aftercooler 20, an intake air conduit in the from of a pipe 30, a liquid trap in the form of a pipe segment 40 which opens into pipe 30 at one end portion 42 and includes an opening 44 at the opposite closed end portion 46. Opening 44 opens into a drip line 50 which feeds into a liquid collection reservoir in the form of a ½-gallon collection tank 60. Tank 60 is equipped with a liquid level sensor 62 and a drain line 64 which may be opened or closed by a ball valve 66.

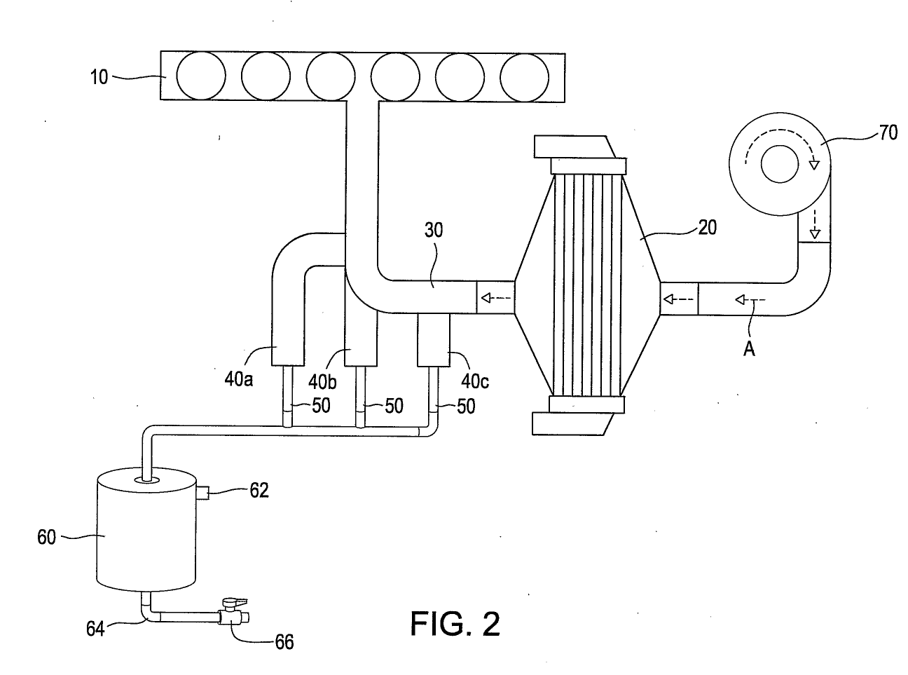

FIG. 2 is illustrative of another particular embodiment of the invention, showing a combustion engine improved with a liquid trap similar to that illustrated in FIG. 1, but including multiple traps (40a, 40b and 40c) disposed along the length of intake air conduit pipe 30. Also shown in FIG. 2 is a representation of the turbocharger 70 which feeds compressed air into aftercooler 20. Each of traps 40a, 40b and 40c drain into drip line 50 to feed condensation liquid into collection tank 60. The arrows A in FIG. 2 indicate the direction of airflow from turbocharger 70 through aftercooler 20 and air intake conduit pipe 30.

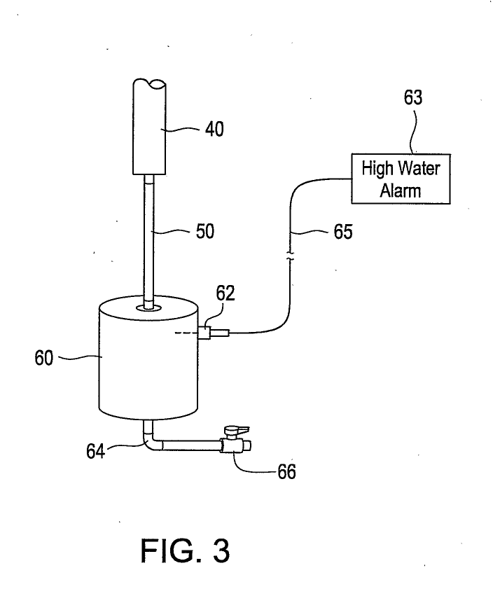

FIG. 3 provides additional illustration of tank 60 and its associated liquid level sensor 62 in operative connection with a highwater alarm 63 through wire 65. Those of skill in the art will understand that virtually any known liquid level sensor may be used as the liquid level sensor component in devices of this invention, as is the case for the highwater alarm, as long as the sensor and, if present, highwater alarm do not inhibit the performance of the rest of the components of the system in accordance with the teachings of this description, but provide notice (e.g., visible or audible notice) to a user that the liquid level within the tank has reached a pre-selected level and may require emptying. Of course, in other embodiments of the invention, the drip line could be configured to simply drain out for disposal in the surroundings exterior to the vehicle or craft being propelled by the engine.

Those of skill in the art will appreciate that the liquid trap of this invention may take a wide variety of forms, just as long as the shape, placement and operation of each trap does not prevent or inhibit liquid condensation, which forms on the inner wall surface of the air intake conduit, from falling into the trap. Ideally, the size and placement of the trap or traps is such that condensation will readily flow into the trap, e.g., through the force of gravity, during normal use of the engine. As depicted in the accompanying figures, the placement of at least one trap at or near the substantially 90 degree turn in the intake conduit is sometimes a preferred trap location (due to the vertical nature of the intake conduit beyond the 90 degree turn and the effects of gravity on condensation inside the conduit), although other locations along the length of the intake conduit can suffice.

### EXAMPLE

A Cummins 8.3 Marine diesel engine was equipped with a single liquid trap at the 90 degree turn in the air intake conduit feeding the crossover (i.e., intake manifold), as depicted in FIG. 1. At 70% throttle, with ambient intake air having a relative humidity around 65%, the liquid trap removed 3-5 ounces of liquid from the air intake conduit during a run time of about 1 hour. When humidity of ambient air was circa 100%, the amount of liquid produced was 12 ounces when running the same engine for the same period of time using the same throttle setting.

The present invention shall not be limited to the particular embodiments illustrated herein, but instead shall include that which is defined by the appended claims and all equivalents thereof permitted as a matter of law.

1. Apparatus comprising a liquid trap sized and configured to be placed in fluid communication with an air intake conduit and to thereby receive at least a portion of condensation which forms within the air intake conduit when the air intake conduit is feeding substantially humid, aftercooled and turbocharged air into an intake manifold of an internal combustion engine.

2. The apparatus according to claim 1 further comprising a collection reservoir, the reservoir being in fluid communication with the liquid trap to receive liquid therefrom.

3. The apparatus according to claim 2 further comprising a liquid level sensor operatively connected to the collection reservoir to thereby detect when a pre-selected level is reached by liquid in the collection reservoir and emit a signal indicating that the pre-selected level has been reached.

4. The apparatus according to claim 3 wherein the liquid trap comprises a hollow conduit configured for fluid communication with the intake air conduit so as to open on one end to an air passageway formed by the air intake conduit, and which hollow conduit is closed on the other end except for a drain opening disposed to feed into a drip line conduit sized and configured to convey liquid from the hollow conduit.

5. The apparatus according to claim 1 wherein the liquid trap comprises a hollow conduit configured for fluid communication with the intake air conduit so as to open on one end to an air passageway formed by the air intake conduit, the hollow conduit being substantially closed on the other end except for a drain opening disposed to feed into a drip line conduit sized and configured to convey liquid from the hollow conduit.

6. The apparatus according to claim 5 further comprising a collection reservoir in fluid communication with the drip line conduit.

7. The apparatus according to claim 6 further comprising a liquid level sensor operatively connected to the collection reservoir to thereby detect when a pre-selected level is reached by liquid in the collection reservoir and emit a signal indicating that the pre-selected level has been reached.

8. In an internal combustion engine equipped with at least an intake manifold, a turbocharger for compressing a flow of intake air, an aftercooler device for reducing the temperature of the intake air flowing from the turbocharger, and an air intake conduit for conveying intake air exiting the aftercooler device to the intake manifold, the improvement comprising at least one device according to claim 1 in fluid communication with the air intake conduit.

9. The improved engine according to claim 8, comprising at least two devices according to claim A1 in fluid communication with the air intake conduit.

10. The improved engine according to claim 8, wherein the engine is a diesel engine.

11. The improved engine according to claim 10 wherein the aftercooler device is a seawater-cooled aftercooler device.

12. The improved engine according to claim 8 wherein the aftercooler device is a seawater-cooled aftercooler device.

13. The improved engine according to claim 8 further comprising a collection reservoir, the reservoir being in fluid communication with the liquid trap to receive liquid therefrom.

14. The improved engine according to claim 13 further comprising a liquid level sensor operatively connected to the reservoir, the level sensor being configured to emit a signal upon detecting that a pre-selected liquid level has been reached by liquid contained within the reservoir.

15. The improved engine according to claim 14 wherein the liquid trap comprises a hollow conduit configured for fluid communication with the intake air conduit so as to open on one end to an air passageway formed by the air intake conduit, and which hollow conduit is closed on the other end except for a drain opening disposed to feed into a drip line conduit sized and configured to convey liquid from the hollow conduit to the reservoir.

16. A method of preventing water damage to a turbocharged, aftercooled internal combustion engine, the process comprising:
collecting in a liquid trap, during operation of the engine, at least a portion of condensation formed in an air intake conduit extending between the aftercooler and the intake manifold, so as to prevent at least an appreciable amount of condensation liquid from entering the intake manifold, the liquid trap being in fluid communication with the air intake conduit.

17. A method according to claim 16, further comprising storing the collected condensation in a collection reservoir which is in fluid communication with the liquid trap.

18. A method according to claims 17, further comprising monitoring for a pre-selected level of condensation liquid in the collection reservoir and generating a warning signal when that pre-selected level of condensation liquid is reached within the collection reservoir.
